(19) United States
(12) Patent Application Publication
(10) Pub. No.: US 2024/0085871 A1
(43) Pub. Date: Mar. 14, 2024

(54) Method and apparatus for treating containers with identification of rejected containers

(71) Applicant: KRONES AG, Neutraubling (DE)

(72) Inventors: Andreas STEINER, Wenzenbach (DE); Robert SZWARC, Neutraubling (DE); Benedikt BOETTCHER, Bruckmühl (DE); Konrad SENN, Alteglofsheim (DE); Philipp OLENBERG, Regensburg (DE); Markus ZOELFL, Metten (DE)

(21) Appl. No.: 18/243,964

(22) Filed: Sep. 8, 2023

(30) Foreign Application Priority Data
Sep. 8, 2022 (DE) 10 2022 122 882.7

(51) Int. Cl. G05B 15/02

(52) U.S. Cl. CPC G05B 15/02

(57) ABSTRACT

Disclosed is a method for treating containers, wherein the containers are transported along a predetermined transport path by a transport device and are treated in a predetermined manner by a first treatment device, wherein predetermined working parameters are used for the treatment of the container, wherein individual containers being inspected after their treatment and at least one variable characteristic of a quality of this container being determined, wherein that at least one identification information is generated by an inspected container and/or an inspection operation can be uniquely identified.

### BACKGROUND OF THE INVENTION

The present invention relates to an apparatus and method for treating containers. The present invention is described with reference to a forming device for forming plastic preforms into plastic containers, which is also a very particularly suitable application for the present invention, since this type of machine has a wide range of control possibilities. However, it is pointed out that the present invention can also be used with other methods and other types of plants.

In the beverage manufacturing industry, it is well known that beverage containers are produced using a plurality of plant components. For example, plastic preforms are first heated and then expanded into plastic bottles using a blow-moulding machine such as a stretch blow-moulding machine. Such bottles can then be printed or labelled, filled and closed, for example.

Over time, such apparatuses have become more and more complicated in their setups and methods. For example, in a blow moulding machine, it is known that the plastic preforms are applied with several pressure levels in order to be expanded. In addition, a stretching bar is usually used to stretch the containers in their longitudinal direction. For this reason, such machines therefore have a plurality of working parameters that can be changed, such as the amount of the individual pressures, the times and periods at which they are applied to the container, the movement of the stretching bar and the like.

There are various quality criteria for beverage containers that should be met. In the state of the art, laboratory measurements are usually carried out for this purpose, such as section weight determination or burst pressure determination. These are destructive measuring methods in which the containers are destroyed. Therefore, they are not suitable for inline measurement. Other measurements such as Topload or Stresscrack are so technologically complex that they cannot be carried out inline either.

However, these measurements are often very important for the performance of the containers, so they are not only used for quality control, but also for process optimisation.

It is therefore known from the prior art that manufactured containers are, for example, randomly removed from the production run and examined. The user can then set the working parameters in such a way that the desired container is obtained.

Currently, therefore, service rejections are used for quality assurance measurements on the machine. However, such measurements are carried out without an assignment to the actual container production. Only if the current rejection time is known to the second the rejection of the containers can be precisely identified in the machine data and, if necessary, further information on these containers can be read out. However, this is a relatively time-consuming process.

In order to reliably save information such as currently associated process parameters or working parameters and associated online measurement data for these containers (for example a wall thickness profile), the recipe parameters always had to be saved manually at the relevant time and the associated wall thicknesses actively saved and/or noted.

For example, it can happen that a machine operator removes a plurality of containers over a certain period of time and initially achieves satisfactory results, but not yet sufficient for him. In the further course of the measurements, it becomes apparent that the first-mentioned results were actually the best achievable. In this case, it is difficult for the machine operator to construct which were the (working) parameters or environmental conditions with which the first-mentioned container was produced.

The present invention is therefore based on the object of providing a possibility for such machines and methods, with which the user can always access the results or working parameters desired by him. In addition, a possibility is to be created to better optimise such machines.

### SUMMARY OF THE INVENTION

In a method for treating containers according to the invention, the containers are transported along a predetermined transport path by means of a transport device and are treated in a predetermined manner by a first treatment device, wherein predetermined working parameters are used for the treatment of the containers. Individual containers are inspected after their treatment and at least one parameter characteristic of a performance of these containers is determined.

According to the invention, the container and the value characteristic of a performance of these containers are uniquely identified and associated with each other by means of identification information. Preferably, identification information is generated by means of which an inspected container or container to be inspected and/or a property characteristic of this container and/or an inspection process can be clearly identified.

By an identifiability of the container or an identification process it is understood in particular that in particular also data are identifiable and/or reconstructable which are characteristic for this container, such as in particular the working parameters with which this container was treated. It is also possible that not the container itself is identified, but rather data that is characteristic of it, such as a point in time at which this container was discharged. It is conceivable that the container itself is no longer present (for example as a result of an invasive or destructive inspection).

In particular, it is possible, for example, to identify a point in time at which this container was discharged from a transport path.

This unique identifiability also makes it possible to determine with which working parameters this container was treated and/or which specific measured values occurred during the treatment of this container, such as pressure values.

When treating containers, for example, certain recipes are used, as mentioned above, certain blowing pressures. Correspondingly, there are also corresponding recipe parameters, which were also referred to above as working parameters.

Preferably, the recipe parameters and the online measured values, such as wall thickness measured values, are stored and preferably continuously stored.

One idea of the invention is that in a first step, production data of a container can be associated with its performance data. Preferably, there are four different data in two classes, wherein the production data (can be collected in production for each container) are classified in the first class and the performance data (only offline or only for selected containers) are classified in the second class. The production data are preferably divided into working parameters ((adjustable) values that can be changed by the operator and machine, such as pressure, speed, moments of switching, etc.), disturbance variables or environmental data ((not influenceable) for example preform quality, hall temperature, etc.) and measurement data ((real time) measurement data that can be collected for all containers and (almost) in real time, such as actual pressures, actual temperatures, wall thicknesses, inspection photos, etc.). The performance data are preferably measurement data that cannot or can only with great difficulty be recorded inline and in real time, such as top load, burst pressure, untwisting torque, etc.

In a second step, which is described in more detail below, a model is preferably developed that can depict a relationship between characteristic production data and performance data.

In a further step, the apparatus can, preferably based on this model, optimise the container performance automatically and/or semi-automatically on the basis of further production data and preferably in real time, in particular also during production and/or in production breaks.

The working parameters, also referred to as production data or characteristic values, can be different values depending on the treatment device.

Preferably, these characteristic values are selected from a group of values that can be determined by simple inline measurements, such as a preform temperature, a blowing pressure, a filling height, a closing torque or a wall thickness of the manufactured containers.

In addition, it can be data that can be determined, for example, with an optical inspection, such as, in particular, occurring defects. For example, neck cracks or bottom lenses can be inspected and/or evaluated. For this purpose, statistical image processing methods can be used, in particular for a pre-processing of images.

In addition, the working parameters can also be machine data such as a transport speed of the containers, a stretching time, a pressure level during pre, intermediate or final blow-moulding, a valve switching time during pre, intermediate or final blow-moulding, a closing torque, a label tension, a start or stop time of the filling process, a volume flow during the filling process or a filling quantity.

In addition, environmental data such as a temperature or a humidity or an air pressure can be recorded.

In addition, data of the packaging material such as an IR absorption coefficient, a preform weight, a preform wall thickness, a material information, a batch number, a label type or a closure colour can be recorded.

Furthermore, the measured values or measurement data can also be characteristic values for a performance of the container, such as a top load, a pinch expansion, a burst pressure, a pressure-, stretch curve, a breaking load capacity (stress crack), or a reopening torque.

The invention now deals with the allocation of these mentioned data sets (which, however, particularly concern the same container). This could also be done via seamless tracking. However, this has limitations if, for example, manual intervention is required in the container flow, e.g. for taking samples. If manual intervention is necessary, the containers are preferably marked on the machine side, in particular lettered and/or numbered and/or characterized. Particularly preferably, this marking is machine-readable, in particular for determining the performance data.

In the current state of the art, a wide variety of measurements are used to check the quality of bottles during the production of PET bottles. The operator/customer preferably examines deliberately rejected bottles (reject) or removes bottles from the bottle flow after the machine/bloc system and takes measurements (offline) on the bottles. In addition, the apparatus itself preferably has inline measuring devices which are suitable and intended for inspecting each container in the apparatus or with which each container can be inspected. Preferably, inline and/or offline measurements are carried out on containers. The inline measurements or the results and/or measured values of the inline measurements are documented in such a way that the container characteristics are associated with the treating station and a data set is available at the data interface for further processing and also for station-by-station analysis.

Up to now, there has been no possibility to link the inline and online measurements (results) with each other. It would be possible, for example, to apply a serial number to the bottle with a coding device, which would enable a back reference to the bottle measured inline. However, such a code (sequential number), which has to be applied permanently and bottle by bottle, is only possible at low outputs by the coding device. At high outputs, no sequential number can be generated, so that tracking via a sequential number is not possible.

Preferably, it is therefore suggested that the data set with the inline measurements is provided in a data structure in which a round counter of the blowing wheel and each measured value within this round per (forming) station and assigned to the respective station is provided at the data interface. In other words, all values of a measurement per (forming) station, including the round counter value, are available in a data structure for each rotation of the blower wheel.

Preferably, the content of this data structure with the new measured values and the new round counter reading is displayed at the data interface with each rotation of the blow-moulding machines. This round counter is preferably applied to the container by coding. Since the frequency per round is lower than the frequency per container, it is possible to computationally compile a new code for application by a laser or similar within one round.

The end result is thus a container which, with the coding of the round number and the embossing of the station number at the bottom of the container, enables an unambiguous assignment to the inline measurement data. Accordingly, an assignment and correlation of all existing machine setting parameters is possible, so that (inline) machine parameters can also be assigned to the offline measurement data.

Accordingly, this procedure results in the possibility of correlating offline measurements with inline measurements when taking samples from a bottle, the possibility of allocation according to treatment or forming stations and the possibility of allocation according to machine parameters.

In a further preferred method, an “automatic inline laboratory” measures the containers or samples. In this way, containers can be removed specifically from the container flow with a handling unit and then measured parallel to production and preferably returned to the container flow.

It can be advantageous that the data and/or measured values are not assigned to one container, but to a group of containers. On the one hand, this can suppress statistical noise or level out individual measurement inaccuracies. On the other hand, it may be technically easier to use entire groups of containers.

In a preferred method, groups of containers are therefore inspected.

Particularly preferably, the containers are glass or plastic containers. In a further preferred method, the containers are still unclosed containers.

It is possible that the inspection is carried out both outside the machine or inside the machine. It is therefore possible that the containers are discharged for the purpose of inspection, or that they are inspected online. Furthermore, the inspection can be invasive or destructive, i.e. the physical properties of the container are changed and/or the container is partially or completely destroyed.

Preferably, the transport device transports the containers individually. Preferably, containers can be selectively discharged from the transport path after the treatment device.

In a further preferred method, the containers are still treated by means of a second treatment device after the first treatment device, and in particular in a different manner than with the first treatment device. Thus, the inspection described here is preferably not a final inspection of a filled and closed container, but in particular an inspection of a semi-finished product such as a still empty blown plastic container.

In a preferred method, the working parameters with which this container was treated are assigned to the inspected container and/or the value characteristic of the performance of the container, in particular by means of the identification information.

In a preferred method, the environmental data and/or measurement data by means of which this container was treated are assigned to the inspected container and/or the value characteristic of the performance, in particular by means of the identification information.

Preferably, both measurement results that are obtained inline and measurement results that were not measured inline, but which are based in particular on the same working parameters, are assigned to each other.

Preferably, the treatment device has a plurality of treatment stations, in particular of the same type, which carry out similar treatment processes on the containers. For example, it can be a forming device which has a plurality of forming stations which each form plastic preforms into plastic containers.

Particularly preferably, the treatment device which has treated this container is also assigned to the inspected container, in particular by means of the identification information.

Preferably, the containers to be inspected are discharged from a transport path of the containers downstream of the treatment device. In this case, off-line measurements are carried out. However, it would also be conceivable to carry out online measurements, i.e. during the transport of the containers.

In a further preferred method, a point in time is recorded at which a particular container was inspected and/or discharged from a transport path. In the simplest case, this point in time is the identification information mentioned above. Particularly preferably, however, the identification information receives or contains a time stamp or an exactly definable time.

Since, as mentioned above, recipe parameters or working parameters and also online measured values such as wall thicknesses are continuously stored, these values can be reconstructed, for example, from a database, with exact time allocation, if required.

Preferably, the exact time stamp is recorded in a simple manner via an identification such as, in particular, a short “reject ID” and can thus be assigned to the containers to be inspected, in particular the rejected sample bottles.

All subsequent protocols about measurements on these containers are preferably recorded and/or documented with this above-mentioned rejection ID or with the identification information. Later (for example, in the case of successful evaluations of the container quality), recipe parameters and also measured values (for example, as a setpoint) for a control loop can be restored reversibly from the database or the DMM (data management machine).

In this way, the invention achieves a high time saving and also a higher security against an unintentional loss of “intermediate status data”. Furthermore, documentation work can be omitted in the process finding or validation of bottles such as PET bottles. Furthermore, a gain in accuracy is also achieved.

In addition, an exact match of online measurement data (later target data for the control) with off-line measurement data found to be good can be established. In this way, a high degree of accuracy is achieved for the subsequent control target.

Thus, the invention also consists of being able to provide an identification, for example a rejection ID, in particular for test material that is rejected or to be rejected, such as test containers, with which all relevant data points assigned to this rejection time, in particular from corresponding digitisation databases (Sitepilot, LD, LMS), can be used subsequently, in particular on the basis of an associated time stamp, for all kinds of applications if required.

In particular, the identification information therefore contains an exact time of a rejection process. Particularly preferred is a time in a format “day-hour-minute and second”, if necessary even finer. In this way, the machine database can be used to record both a treatment device or treatment station that has treated this container and the working parameters valid at this time as well as any measured values that have occurred for this container.

Particularly preferably, measured values are also recorded during the treatment of the container, which are characteristic for this treatment. These measured values can be, for example, measured pressure values, measured flow values, temperatures and the like. These measured values are also preferably recorded.

In a further advantageous method, a plurality of containers are inspected and, preferably, a model for controlling the treatment device is derived from the measured values determined during these inspections.

Preferably, all available data from the largest possible number of containers and a wide variance of production data and performance data and/or measured values is now brought together and/or assigned to each other and preferably a model is formed from this.

Various possibilities can be considered for model building. For example, classical correlation analyses or dimensional analyses can be carried out. Relationships can also be modelled with the help of mathematical fit functions.

Furthermore, a model can be generated with the help of an expert. Also conceivable are various AI methods, such as a neural network, reinforcement learning or physical-based AI, which generate a model.

Preferably, the determination of working parameters is performed with an (artificial) neural network and in particular on (computer-implemented) machine learning methods based on at least one, and in particular exactly one, (artificial) neural network. Preferably, the simulation container inspection machine learning model is based on an (artificial) neural network.

The data that flows into the model can be generated during standard production or in special production runs in which specific parameters are varied.

It is also conceivable to combine both methods and to generate a basic set of data for a basic model in a “teaching run” and then gradually feed data into the system during ongoing production and, if necessary, refine the model.

Preferably, the neural network is designed as a deep neural network (DNN), in which the parameterisable processing chain has a plurality of processing layers, and/or a so-called convolutional neural network (CNN) and/or a recurrent neural network (RNN).

Preferably, the model or the (artificial) neural network is supplied with the data (to be processed), in particular the sensor data (or data derived therefrom), as input variables. Preferably, the model or the artificial neural network maps the input variables to output variables in dependence on a parameterisable processing chain, wherein the measurement variables are preferably selected as output variables and preferably a plurality of measurement variables are selected as output variables.

Preferably, the system now adjusts the performance of the containers to the target performance during the production run (or during short breaks), in particular on the basis of the existing model.

For this purpose, the treatment device preferably tries to adjust the influenceable production data in such a way that the desired performance is achieved.

In the case of production data, a distinction is preferably made between three different types of data and/or parameters, namely, on the one hand, between data or parameters that can be influenced directly (e.g. machine speed or filling pressure), parameters that can be influenced indirectly (wall thickness distribution, preform temperature at the oven outlet or filling level) and values that cannot be influenced (air humidity, IR absorption behaviour or hall temperature).

In order to achieve the desired target performance, different cascaded models may be used. It is conceivable, for example, that there is a model that adapts a variable that can be influenced indirectly (e.g. wall thickness distribution) by adapting values that can be influenced directly (e.g. heating plate or stretching speed) in such a way that the wall thickness stored in the main model is generated for the current hall temperature in order to achieve the target performance.

A further point that can preferably be included in the model are constraints such as energy demand or filling pressure. For example, an attempt can be made to come as close as possible to the target performance with a minimum energy requirement.

It is also conceivable that the model is gradually sharpened by repeatedly collecting performance data and comparing it with the model forecast data.

The present invention will now be explained by means of a concrete example, namely a blow moulding machine. Such blow moulding machines have a rotatable transport carrier on which a plurality of forming stations are arranged which form plastic preforms into plastic containers. Furthermore, these machines preferably also have stretching units which stretch the plastic preforms in their longitudinal direction. Preferably, these machines also have process controls that regulate the forming processes, in particular individually for each forming station.

Already during process determination or validation of the container quality, several sample bottles are preferably rejected and subsequently subjected to online quality tests or, in particular, offline quality tests. In the process, optimisation loops are preferably run and iterative optimisation loops are preferably run until the quality tests are found to be good.

If it turns out that the best result was already found in the early stages of this optimisation loop and no further improvement could be found afterwards despite prolonged efforts, these initial results would also be accepted as a compromise if necessary.

In this case, the problem can arise in the prior art that the associated setting parameters and, if applicable, online measurement values such as wall thickness measurement values, bottom inspection values and the like for this “best result” are no longer known or have not been stored.

If, however, as suggested by the invention, a rejection ID has been noted along with this best result, in particular the above-mentioned identification information, both the setting parameters of the machine and a corresponding control target (the online quality criteria) such as wall thickness course, soil information and the like can be recovered. This can be done, for example, by entering the identification information on a machine, wherein digitalization databases can be used for this purpose in particular.

Further storage of process data is no longer mandatory. In this way, parameters that are important for a machine, such as the basic setpoint setting parameters of the machine or a target definition of the control, such as a wall thickness profile, can be restored or retrieved in a much simpler way.

In the following, off-line measurements are understood to be those measurements on containers which are carried out outside a manufacturing plant and which are ultimately intended to prove whether the container meets the required quality standards. These measurements include, for example, measurements of section weights, shelf life, thermal tests and the like. Shelf life preferably refers to the shelf life of a product, e.g. how long does a beverage hold the required amount of CO2 at a given temperature.

Online measurements are understood to be measurements that can be taken during production and in particular without rejecting containers (such as wall thickness measurements, optical measurement methods for forming and stretching and the like).

If these measurements correlate sufficiently well with the actual quality requirements, off-line measurements can be reduced or eliminated altogether.

Preferably, however, as mentioned above, offline measurements and online measurements that were performed on the same container or the same group of containers are also assigned to each other.

In a further preferred method, both off-line measurements, i.e. measurements in which the containers are discharged, and on-line measurements, which are carried out during production, are performed. Preferably, identification information can be specified or output both for these offline measurements and for online measurements.

The identification information (also called rejection ID) prevents good settings from being lost and process work from having to be done several times. Since the offline quality measurements often run parallel to the container optimisation, it can easily happen that good intermediate results are simply lost again because the associated setting parameters have not been saved back. In difficult cases, the customer may initially insist on further optimisation because of minor failures, but in the end the previously rejected intermediate status is accepted.

A requirement for consistent quality for all containers is usually difficult to fulfil afterwards, since on the one hand the associated conditions can no longer be reconstructed and on the other hand the information is partly only available in the form of measurement data, since the measurement methods were not non-destructive.

However, if a rejection ID or the identification information is assigned to the containers, as is proposed within the scope of the invention, the complete setting parameters of the forming device, as well as the associated online measurement data for these containers, can be transferred from the database back into the machine and into the measuring unit using this information alone, in particular in conjunction with an associated time stamp.

In the following, a control target refers to the online measurement results, such as wall thicknesses, which are preferably stored in the control system as target values. Process specifications made by the control system aim to achieve this control target as well as possible.

The information or the rejection ID creates the possibility to exactly match the online control target with the “best offline measurement data”. Currently, the target values of the online measurement data are recorded by the measurement system during the teach-in phase (DoE (statistical design of experiments)) and finally transferred to the control system.

These are preferably not identically those values that were achieved in the validation process, but “only” those online measurement values that result from repeating the best setting parameters (best setpoint settings) from the validation process now in the teach-in phase (DoE).

Since the interferences to be balanced can cause a deterioration of the container quality even with identical setting parameters, there is a risk that during the teach-in phase not the best possible wall thickness distribution from the validation process but, if necessary, a less favourable wall thickness profile is stored as the control target. The control target would thus be worse than desired by a customer.

If, however, the respective identification information for the rejected test containers is available in the validation process, not only the complete setting parameters of the stretch blow moulder (best-setpoint settings), but also the associated online measurement data for these containers can be transferred from the database alone, in conjunction with the associated time stamp data, back into the measuring unit and into the control system as a perfect control target.

In a further preferred method, the identification information is stored or written together with a time stamp in the database data, in particular the DMM (data management machine) data.

In a further preferred method, therefore, as mentioned above, a point in time is recorded at which a particular container is inspected and/or discharged from a transport path.

As mentioned above, the identification information preferably contains a time stamp or a feature characteristic for a point in time. Preferably, the identification information is stored with a time stamp.

In a preferred method, a model is created that combines production data (working parameters and/or environmental data and/or measurement data) and performance data. Preferably, the container performance is optimised based on production data and the model in (real time).

In a preferred method, the production data, preferably working parameters, are therefore adjusted based on the model to achieve optimal performance data.

In a further preferred method, the identification information is generated and/or can be generated by user intervention. Therefore, it is possible that the identification information is not generated automatically or by default, but only when requested by the user.

Preferably, the rejection of the containers for the purpose of inspection is separated from the conventional rejection (for example of faulty containers).

Preferably, the identification information is kept short. For example, the identification information can contain a date and a sequential number (wherein the sequential number preferably starts new every day). In addition, an index (a, b, c, . . . ) can be provided.

If many offline tests are required, several rejections may be necessary when rejecting an operating state.

In the case of major (and/or several) rejections, the index (a, b, c, . . . ) should be added.

This should preferably only be possible if the discharges take place within two minutes.

Preferably, the determined data can be stored in a cloud-based database as well as in a customer-side and/or local database.

In a further preferred method, the treatment device is selected from a group of treatment devices comprising heating devices for heating plastic preforms, forming devices for forming plastic preforms into plastic containers, labelling devices for labelling containers, filling devices for filling containers, printing devices for printing containers and closing devices for closing containers.

In a further preferred method, the treatment of the containers is selected from a group of treatment operations including heating plastic containers, forming plastic preforms into plastic containers, labelling containers, filling containers, printing containers and closing containers.

In a further preferred method, the characteristic value is selected from a group of values including a wall thickness of the container, optical properties of the container, properties of a label disposed on the container, properties of an imprint disposed on the container, and the like.

Preferably, the characteristic value is a property that can be determined by inspection and which allows conclusions to be drawn about the treatment or the treatment process.

In a preferred method, the working parameter is selected from a group of working parameters including a pressure applied to a plastic preform, the movement of a stretching bar with which the plastic preform is stretched, times and/or periods of an application of the plastic preforms and the like.

In particular, it is possible to set these working parameters individually for a plurality of forming stations.

However, such working parameters can also be made on other machines, for example, on a labelling machine, the temperature of a glue with which a label is applied, or on a closing machine, a torque with which a closure is screwed on and the like.

The present invention is further directed to an apparatus for treating containers, comprising a transport device which transports the containers along a predetermined transport path and a first treatment device which treats the containers in a predetermined manner, wherein the first treatment device uses predetermined working parameters for the treatment of the container or the containers.

Furthermore, a rejection device arranged after the first treatment device is provided in order to reject individual containers treated by the treatment device from the transport path and/or an inspection device arranged after the first treatment device for inspecting containers treated by the first treatment device.

According to the invention, the apparatus has an information generating device for generating at least one identification information by means of which the container and the value characteristic of a performance of these containers can be uniquely identified and associated with one another. Preferably, the identification information uniquely identifies a container to be inspected and/or an inspection process.

It is therefore also suggested on the apparatus side that an identification of a container or a rejection process or the like is carried out. In this way, certain containers can also be assigned to certain working parameters at a later date.

Preferably, the apparatus has an assignment device which assigns a container to be inspected working parameters by means of which this container has been treated. This can be done, as mentioned above, for example by applying a time stamp.

Preferably, the assignment device is also suitable and intended for assigning to an inspected container or a container to be inspected a treatment station which has treated this container.

In a preferred embodiment, the working parameters are adjustable based on a model to achieve optimal performance data.

In the context of the present application, the treatment equipment is understood to be an entire device, which may, however, comprise several treatment stations. In the case of a forming machine, the treatment device is the entire forming device, which, however, comprises a plurality of forming stations, each of which is suitable and intended for forming plastic preforms into plastic containers.

In a further preferred method, the apparatus has in addition, in particular in addition to a rejection device, an inspection device which inspects the treated containers after their treatment, wherein this further inspection device being in particular an online inspection device. Preferably, at least one value characteristic of a quality of these containers can be determined.

Particularly preferably, the forming device described here has a rotatable carrier on which a plurality of forming stations are arranged. Preferably, each of these forming stations has a blow mould within which the plastic preforms can be formed into the plastic containers. Furthermore, each forming station preferably has a stretching unit which is suitable and intended for stretching the plastic preforms in their longitudinal direction.

Preferably, each forming station also has a valve arrangement, such as in particular but not exclusively a valve block, which has a plurality of valves, in particular to apply different pressure levels to the plastic preforms.

Particularly preferably, the forming device has at least one and preferably several, in particular at least three pressure reservoirs, which are suitable and intended for applying different pressure levels to the plastic preforms. Preferably, these pressure reservoirs are arranged on or at the movable carrier.

Preferably, the treatment device is followed by a further treatment device along the transport path of the containers, which treats the containers in a further but different manner.

The invention therefore makes use of the fact that, for example, recipe parameters and online measurement data such as wall thicknesses are stored continuously anyway. With an exact time allocation, the desired values can be reconstructed retrospectively from a database, for example.

In a further preferred embodiment, the apparatus has a marking device which applies a marking to the containers, in particular to the containers which have been rejected or are to be rejected. In this way, an allocation can be made later. This marking can also indicate, for example, the working parameters with which this container was produced.

Further advantages and embodiments can be seen in the attached drawings:

### BRIEF DESCRIPTION OF THE DRAWINGS

In the drawings:

FIG. 1 shows a representation of an installation according to the invention for the production of containers; and

FIG. 2 shows an illustration of a method according to the invention.

### DETAILED DESCRIPTION OF THE INVENTION

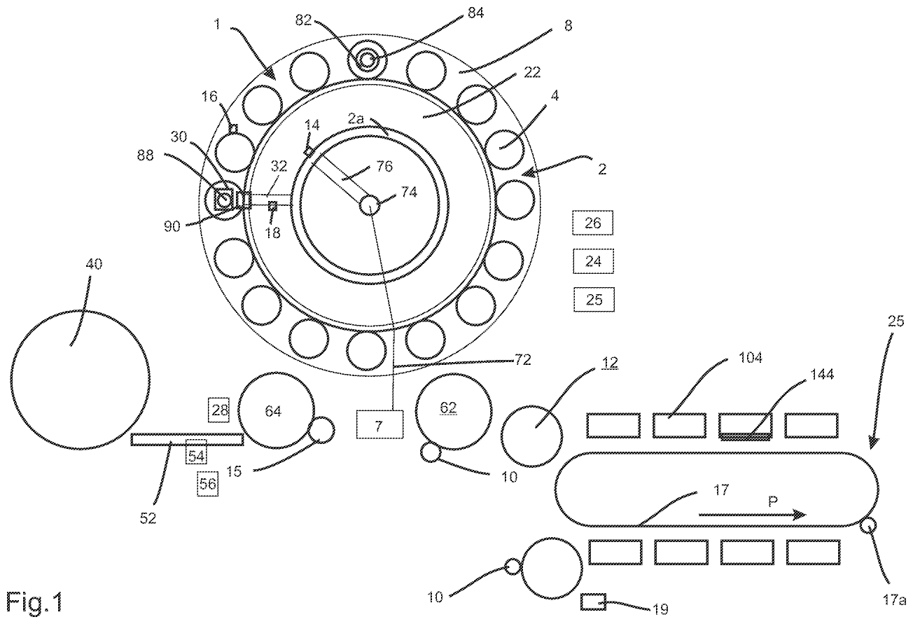

FIG. 1 shows an apparatus 1 for forming plastic preforms 10 into plastic containers 15. In this case, this is also the treatment device for treating containers. This apparatus 1 has a rotatable carrier 22 on which a plurality of forming stations 4 are arranged. These individual forming stations each have blow moulding devices 82 which form a cavity in their interior for expanding the plastic preforms.

The reference sign 84 indicates an application device which serves to expand the plastic preforms 10. This can be, for example, a blow nozzle which can be placed against a mouth of the plastic preforms in order to expand them. In addition, it would also be conceivable for the blow nozzle to seal against the blow moulding device. Preferably, this application device is movable in a longitudinal direction and preferably exclusively in a longitudinal direction of the plastic preforms.

The reference sign 90 indicates a valve arrangement such as a valve block, which preferably has a plurality of valves that control the application of different pressure levels to the plastic preforms. Preferably, each forming station has such a valve block.

In a preferred process, the plastic preforms are first applied with a pre-blowing pressure P1, then with at least one intermediate blowing pressure Pi, which is higher than the pre-blowing pressure, and finally with a final blowing pressure P2, which is higher than the intermediate blowing pressure Pi. After expansion of the plastic containers, the pressures or compressed air are preferably returned from the container to the individual pressure reservoirs. Preferably, a further pressure stage, in particular a further intermediate blowing pressure, is provided.

The reference sign 88 indicates a stretching rod which is used to stretch the plastic preforms in their longitudinal direction. Preferably, all forming stations have such blow moulds 82 as well as stretching rods 88. This stretching rod is preferably part of a stretching device designated 30. The stretching rod is (preferably also exclusively) movable in the longitudinal direction of the plastic preforms 10.

Preferably, the number of these forming stations 4 is between 2 and 100, preferably between 4 and 60, more preferably between 6 and 40.

The plastic preforms 10 are supplied to the apparatus, i.e. the treatment device, via a first transport device 62, such as in particular but not exclusively a transport starwheel. The plastic containers 15 are transported away via a second transport device 64.

The reference sign 7 indicates a pressure supply device such as a compressor or also a compressed air connection. The compressed air is supplied via a connection line 72 to a rotary distributor 74 and from there via a further line 76 to a compressed air reservoir 2a, which is preferably an annular channel. This rotary distributor thus preferably serves for supplying air from a stationary part of the apparatus into a rotating part of the apparatus.

In addition to this ring channel 2a shown, further ring channels are preferably provided, but in the illustration shown in FIG. 1 they are concealed by the ring channel 2a, for example they are located below it. The reference sign 32 indicates a connection line which delivers the compressed air to a forming station 4 or its valve block 90. Preferably, each of the ring channels is connected to all forming stations via corresponding connecting lines. This connection line is preferably arranged in the rotating part of the apparatus.

The reference sign 8 schematically indicates an optional clean room, which is preferably ring-shaped here and surrounds the transport path of the plastic preforms 10. Preferably, a (geo-metric) axis of rotation with respect to which the transport carrier 22 is rotatable is arranged outside the clean room 8. Preferably, the clean room is sealed off from the non-sterile environment by a sealing device, which preferably has at least two water locks.

Furthermore, the apparatus has a ceiling device (not shown in FIG. 1) which delimits the clean room 8 at the top. This ceiling device is preferably arranged on at least one of the stretching devices 30.

The apparatus has a plurality of measuring and/or sensor devices which serve to control the apparatus. The reference sign 14 indicates a pressure measuring device which measures an air pressure inside the compressed air reservoir 2a. Preferably, the other compressed air reservoirs also have corresponding pressure measuring devices.

The reference sign 16 indicates a further pressure measuring device which measures an air pressure, in particular an internal container pressure of the plastic preform to be expanded. Preferably, such a pressure measuring device is assigned to each forming station.

The reference sign 18 also schematically indicates a flow measuring device which determines a flow of the blowing air from a compressed air reservoir to the valve block 90 of a forming station 4. Preferably, corresponding flow measuring devices are arranged between a compressed air reservoir and all forming stations.

Further flow measuring devices can also be assigned between the further compressed air reservoirs and the respective forming stations.

Furthermore, position detection devices are preferably also provided, which can detect positions of the stretching rods of the individual forming stations.

The reference sign 24 indicates a control device that controls and, in particular, regulates the apparatus 1. This control device is preferably also capable of changing the working parameters of the apparatus.

Preferably, the above-mentioned measuring or sensor devices continuously output sensor or measurement data, which are particularly preferably stored. On the basis of this measurement or sensor data, an AI can, for example, determine ideal working parameters for the operation of the treatment device 1.

In particular, the control device controls the individual valves and thus the application of the individual pressure levels to the plastic preforms. In addition, the control device preferably also controls a movement of the stretching rods of the individual forming stations. Preferably, the control device also controls movements of the application devices, i.e. the blow nozzles. The control device is therefore preferably suitable for controlling the times at which the application devices are placed on the plastic preforms and/or the times at which the blow moulding devices are lifted off from the plastic preforms again, and in particular also for changing these times.

The reference sign 26 indicates a storage device in which in particular measured variables are recorded, in particular pressure values and flow rate values, but also corresponding working parameters. Preferably, these respective values are stored with a time allocation.

Preferably, these values can be stored continuously and in particular over long periods of machine operation. The control device also controls or regulates the apparatus taking into account these recorded measured values.

The reference sign 28 roughly schematically indicates an inspection device for inspecting the manufactured containers. Preferably, an allocation device is also provided, which is suitable and intended for allocating to a particular inspected container those working parameters which were used for the manufacture of this container

The reference sign 25 indicates a display device that serves to output information to a machine operator. This display device can be used, for example, to output measured pressure (course) curves.

The reference sign 52 indicates a transport device by means of which blown plastic containers are transported to a filling device 40. This filling device thus represents a further treatment device.

The reference sign 54 indicates a rejection device which is used to reject containers produced by the forming device for the purpose of inspecting them. Reference 56 indicates a generating device for generating identification information.

This generation device can, for example, attach identification information in the form of a mark to the container to be inspected or rejected. However, it would also be conceivable for the generation device to generate identification information which contains, for example, an exact time of rejection and which is stored in a memory device.

Based on this identification, a rejected container and/or at least one piece of information associated with this container, such as a time of its rejection, can be stored.

On the basis of this identification information, it can also be determined, for example, from which forming station 4 and/or with which working parameters this rejected container was treated. It is also possible to determine which environmental conditions existed at the time of rejection.

If necessary, using this identification information and in particular a time, further containers can also be identified which were formed with the same forming station in the same time period. In this way, values can also be assigned to the container which were recorded with the inspection device for such containers.

The reference sign 25 indicates a heating device which heats the plastic preforms to be formed by the forming device. This heating device has a transport device 17 which transports the plastic preforms to be heated during their heating. A plurality of holding devices for holding the plastic preforms 10 are arranged on this transport device.

The reference sign 19 indicates a blocking device which can block the entry of plastic preforms into the heating device.

A plurality of (preferably stationary) heating devices 104 are arranged along the transport path of the plastic preforms to be heated, each of which has a plurality of infrared radiators 144. The reference sign 12 indicates a transport device which transports the heated plastic preforms further from the heating device 25.

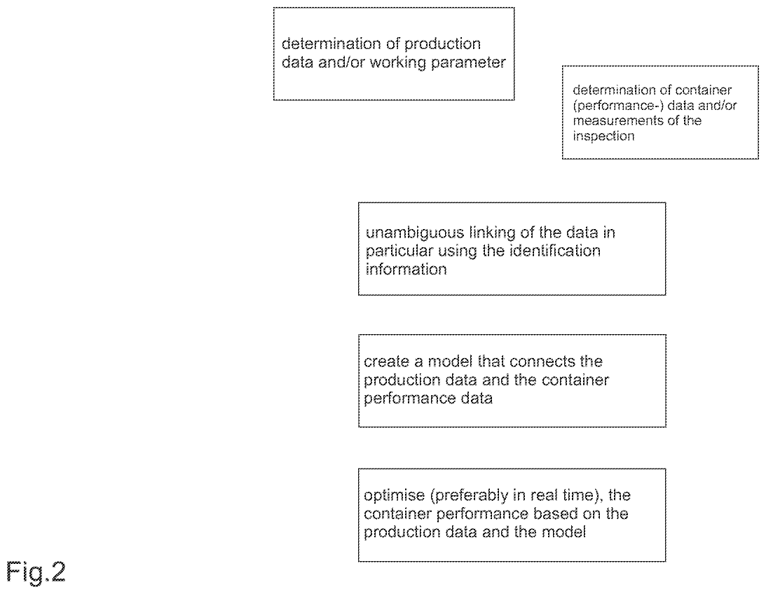

FIG. 2 shows a rough schematic sequence of a method according to the invention. Production data or working parameters are determined, in particular during operation. These are preferably determined permanently and/or continuously.

Furthermore, container performance data or the above-mentioned measured values, such as wall thickness, are determined on certain inspected containers.

These working parameters and the container performance data are assigned to each other and, in particular, uniquely linked to each other. The identification information mentioned above serves for this purpose in particular.

Furthermore, a model is preferably created on the basis of a plurality of such interconnected data, which in particular describes the treatment process. In particular, this model also takes into account the interconnected data.

The model can, for example, describe how certain working parameters affect the treated containers.

Preferably, the container performance is optimised on the basis of the working parameters and the model, which can in particular also take place during ongoing operation and/or in real time.

The applicant reserves the right to claim all features disclosed in the application documents as essential to the invention if they are individually or in combination new compared to the prior art. It is further pointed out that the individual figures also describe features which may be advantageous in themselves. The skilled person immediately recognizes that a certain feature described in a figure can also be advantageous without adopting further features from this figure. Furthermore, the skilled person recognizes that advantages can also result from a combination of several features shown in individual figures or in different figures.

1. A method for treating containers, wherein the containers are transported along a predetermined transport path by a transport device and are treated in a predetermined manner by a first treatment device, wherein predetermined working parameters are used for the treatment of the container, wherein individual containers are inspected after their treatment and at least one value characteristic of a performance of the container is determined,
wherein
the container and the value characteristic of a performance of these containers are unambiguously identified and associated with one another by identification information.

2. The method according to claim 1,
wherein
the work parameters by which the container was treated are assigned to the inspected container and/or to the value characteristic of the performance.

3. The method according to claim 1,
wherein
the environmental data and/or measurement data by which the container treated are assigned to the inspected container and/or the value characteristic of the performance.

4. The method according to claim 1,
wherein
a marking is applied to a container to be inspected.

5. The method according to claim 1,
wherein
the containers to be inspected are rejected from a transport path of the containers.

6. The method according to claim 1,
wherein
a point in time is detected at which a specific container is inspected and/or rejected from a transport path.

7. The method according to claim 1,
wherein
the identification information contains a time stamp.

8. The method according to claim 1,
wherein
the identification information is stored.

9. The method according to claim 1,
wherein
a model is created that combines production data and performance data.

10. The method according to claim 9, wherein the production data are selected from work parameters, environmental data, measurement data and combinations thereof.

11. The method according to claim 9,
wherein
the working parameters are adjusted based on the model to achieve optimal performance data.

12. The method according to claim 1,
wherein
a plurality of containers are inspected and a model for controlling the treatment device is derived from the measured values determined during inspections.

13. The method according to claim 1,
wherein
the treatment device is selected from a group of treatment devices comprising heating devices for heating plastic preforms, forming devices for forming plastic preforms into plastic containers, labelling devices for labelling containers, filling devices for filling containers, printing devices for printing containers and closing devices for closing containers and/or the treatment of the containers is selected from a group of treatment operations comprising heating of plastic containers, forming of plastic preforms into plastic containers, labelling of containers, filling of containers, printing of containers and closing of containers.

14. The method according to claim 9,
wherein
the production data are working parameters and/or, interference values or environmental parameters and/or measurement data.

15. The method according to claim 9,
wherein
the performance data are measurement data that cannot be recorded inline and in real time, or only with difficulty.

16. An apparatus for treating containers, having a transport device which transports the containers along a predetermined transport path, and having a first treatment device which treats the containers in a predetermined manner, wherein the first treatment device using predetermined working parameters for the treatment of the containers, and having a discharge device arranged downstream of the first treatment device in order to discharge individual containers treated by the treatment device from the transport path and/or an inspection device arranged downstream of the first treatment device in order to inspect the containers treated by the first treatment device,
wherein
the apparatus has an information-generating device for generating at least one identification information for the container and the variable which is characteristic of a performance of these containers can be uniquely identified and brought into association with one another.

17. The apparatus according to claim 16,
wherein
the apparatus comprises an assignment device which assigns a container to be inspected and/or to the value characteristic of the performance working parameters using this treated container.

18. The apparatus according to claim 16,
wherein
the working parameters are adjustable based on a model to achieve optimal performance data.
